(19) United States
(12) Patent Application Publication
(10) Pub. No.: US 2020/0049926 A1
(43) Pub. Date: Feb. 13, 2020

(54) LENS MODULE

(71) Applicant: AAC Technologies Pte. Ltd., Singapore city (SG)

(72) Inventor: Chuandong Wei, Shenzhen (CN)

(21) Appl. No.: 16/528,678

(22) Filed: Aug. 1, 2019

(30) Foreign Application Priority Data
Aug. 7, 2018 (CN) 201821263554.0

(51) Int. Cl. G02B 7/02

(52) U.S. Cl. CPC G02B 7/021

(57) ABSTRACT

The present disclosure relates to the field of optical lenses, and discloses a lens module. The lens module includes a lens barrel, a first lens arranged at an object side of the lens barrel, and a fixing part for pressing the first lens against the lens barrel from an object side of the first lens. The lens barrel includes an outer wall surface around an optical axis of the lens module and facing away from the optical axis, and the outer wall surface is provided with at least one first groove. The fixing part includes an outer annular surface facing away from the optical axis, and the outer annular surface is provided with at least one second groove. The lens module can be assembled in an easier way.

### TECHNICAL FIELD

The present disclosure relates to the technical field of optical lenses, and in particular, to a lens module.

### BACKGROUND

With development of technologies, various devices are equipped with a lens module. For example, with respect to the safety hazard during driving a vehicle, the vehicle is equipped with a vehicle-mounted lens module. In the related art, the vehicle-mounted lens module usually includes a lens barrel and a plurality of lenses received in the lens barrel.

The inventors have found the following problem existing in the related art: components of the vehicle-mounted lens module, during assembling, cannot be easily accessed and fixed, which makes the assembling of the vehicle-mounted lens module difficult. Therefore, it is urgent to provide a new lens module to solve the above problem.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a structural schematic diagram of a cross-section of a lens module according to an embodiment of the present disclosure;

FIG. 2 is a cross-sectional view of a lens barrel according to an embodiment of the present disclosure;

FIG. 3 is a top view of the lens barrel shown in FIG. 2;

FIG. 4 is a cross-sectional view of a lens barrel according to another embodiment of the present disclosure;

FIG. 5 is a top view of the lens barrel shown in FIG. 4;

FIG. 6 is a cross-sectional view of a fixing part according to an embodiment of the present disclosure;

FIG. 7 is a top view of the fixing part shown in FIG. 6;

FIG. 8 is a cross-sectional view of a fixing part according to another embodiment of the present disclosure;

FIG. 9 is a top view of the fixing part shown in FIG. 8;

FIG. 10 is a cross-sectional view of a fixing part according to yet another embodiment of the present disclosure;

FIG. 11 is a top view of the fixing part shown in FIG. 10;

FIG. 12 is a cross-sectional view of a fixing part according to yet another embodiment of the present disclosure; and

FIG. 13 is a top view of the fixing part shown in FIG. 12.

### DESCRIPTION OF EMBODIMENTS

The present disclosure will be further illustrated with reference to the accompanying drawings and the embodiments.

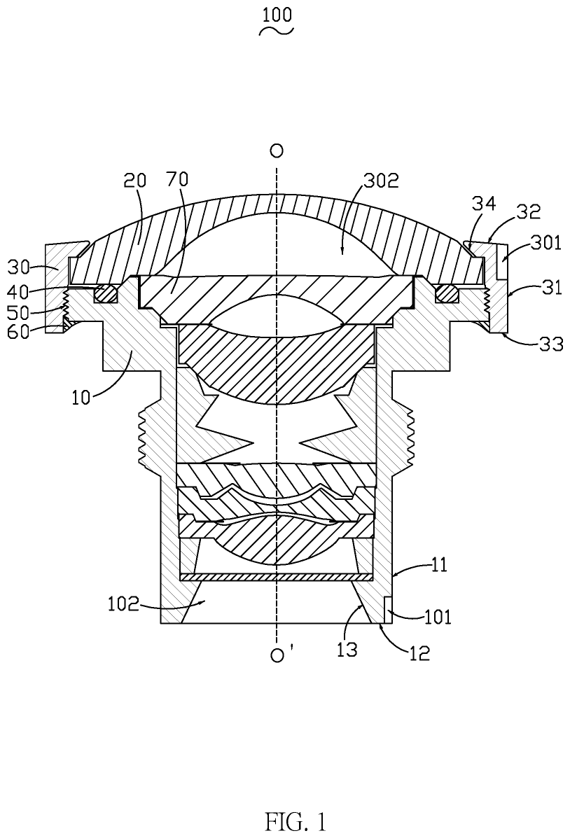

An embodiment of the present disclosure provides a lens module 100. As shown in FIG. 1, the lens module 100 includes a lens barrel 10, a first lens 20 arranged at an object side of the lens barrel 10, and a fixing part 30 for pressing the first lens 20 against the lens barrel 10 from an object side of the first lens 20. The lens barrel 10 includes an outer wall surface 11 around an optical axis OO′ of the lens module 100 and facing away from the optical axis OO′. The outer wall surface 11 is provided with a first groove 101. The fixing part 30 includes an outer annular surface 31 facing away from the optical axis OO′, and the outer annular surface 31 is provided with a second groove 301.

Compared with the related art, in this embodiment of the present disclosure, the fixing part 30 presses the first lens 20 against the lens barrel 10 to fix the first lens 20 to the lens barrel 10, thereby establishing a stable fixation structure between the fixing part 30 and the first lens 20. Since the outer wall surface 11 of the lens barrel 10 is provided with the first groove 101, by fitting a fitting structure such as a buckle, a mechanical claw within the first groove 101 during the assembling, the lens barrel 10 can be fixed to an assembly platform, so as to facilitate the assembling. Since the outer annular surface 31 of the fixing part 30 is provided with the second groove 301, an assembling tool can easily operate, such as grasp, position, the fixing part 30, thereby facilitating the assembling of the lens module 100.

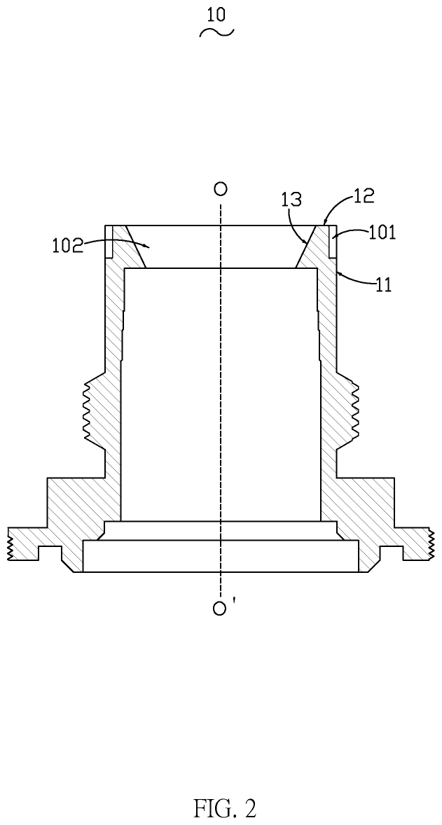

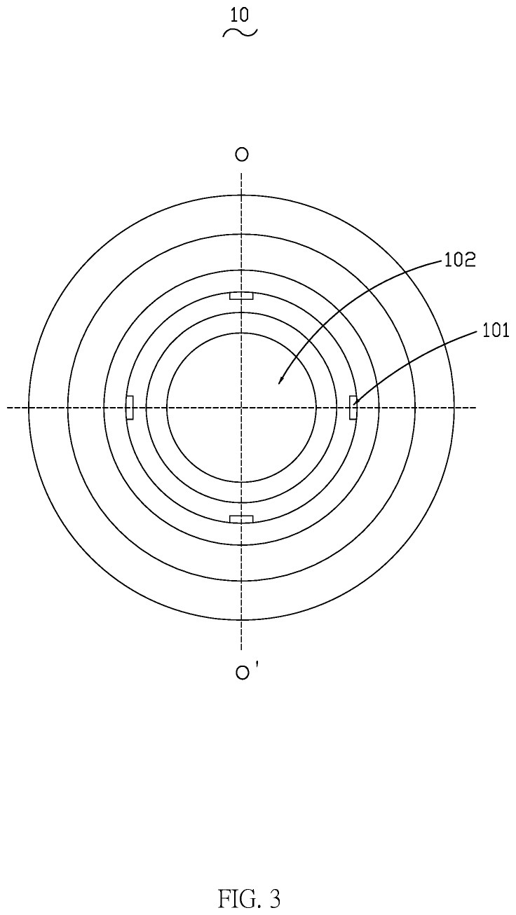

For example, the lens barrel 10 includes an outer wall surface 11, an end surface 12 close to an image side and connected to the outer wall surface 11, and an inner wall surface 13 around the optical axis OO′ and facing towards the optical axis OO′. The inner wall surface 13 defines a first receiving space 102. In an embodiment as shown in FIG. 2 and FIG. 3, the first groove 101 provided on the outer wall surface 11 is connected to the end surface 12, so that a structure such as a buckle, a mechanical claw or the like can be easily and directly fitted in the first groove 101 provided on the outer wall surface 11 of the lens barrel 10 from the image side, so as easily fix the lens barrel 10.

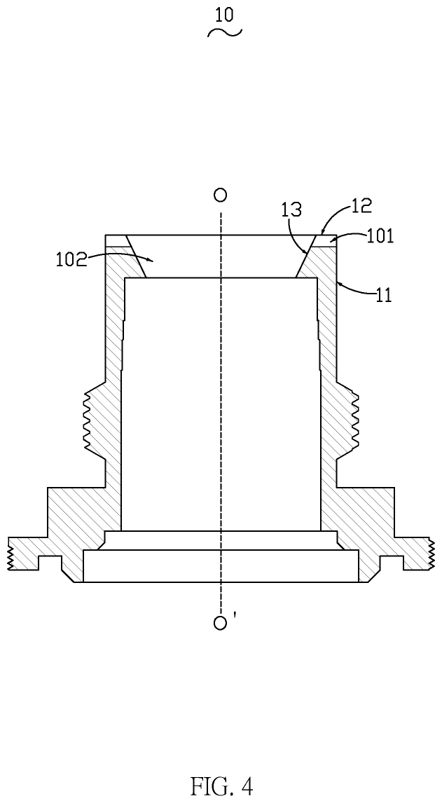

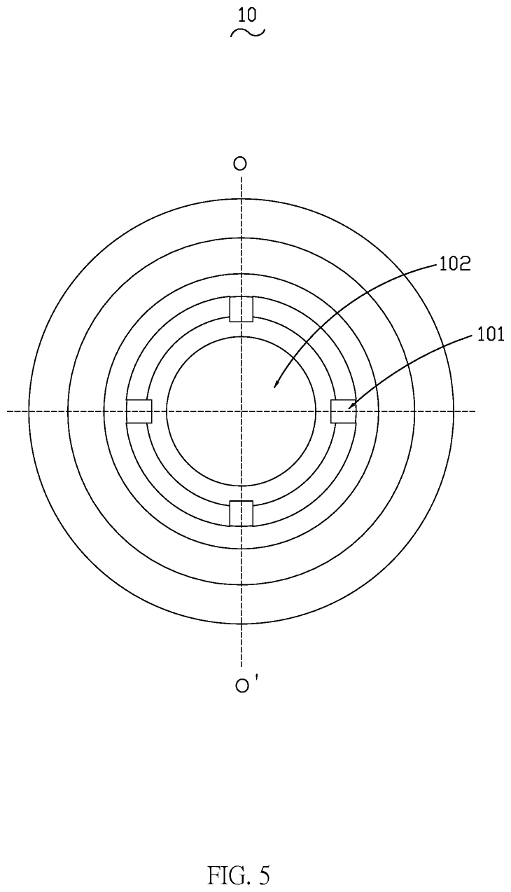

In an embodiment, as shown in FIG. 4 and FIG. 5, the first groove 101 is connected to the inner wall surface 13 and communicates with the first receiving space 102. In this way, it is easy to hold and fix the lens barrel 10 with the assembly platform from an image side of the lens barrel 10, thereby prevent the lens barrel 10 from rotating.

It should be noted that at least two first grooves 101 are provided, and the first grooves 101 are equally spaced apart from each other around the optical axis OO′. For example, as shown in FIGS. 2-5, the lens barrel 10 is provided with four first grooves 101. With such an arrangement, the lens barrel 10 can be subjected to uniform force, so as to avoid looseness of the lens barrel 10 after being fixed, thereby ensuring an accurate positioning and firm fixing of the lens barrel 10.

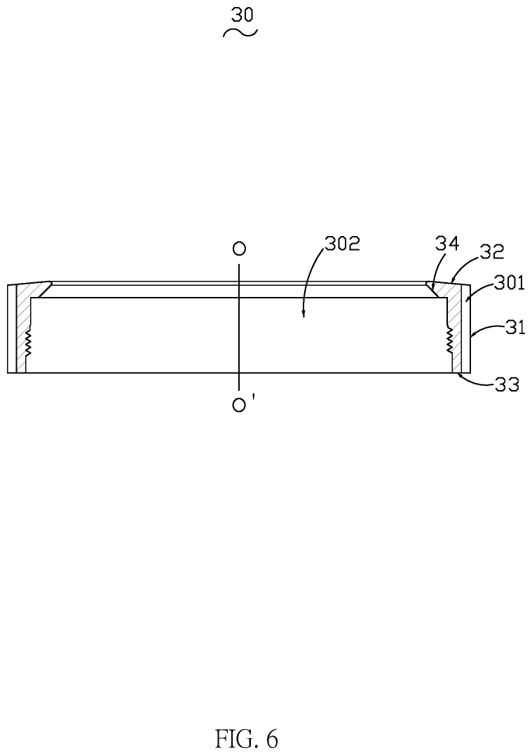

For example, the fixing part 30 further includes an object side surface 32 close to the object side and connected to the outer annular surface 31, an image side surface 33 close to the image side and connected to the outer annular surface 31, and an inner annular surface 34 around the optical axis OO′ and facing towards the optical axis OO′. The inner annular surface 34 defines a second receiving space 302. In this embodiment, with reference to FIGS. 6-11, the second groove 301 is connected to the object side surface 32, facilitating fitting in the second groove 301 provided at the outer annular surface 31 of the fixing part 30 from the object side during the assembling.

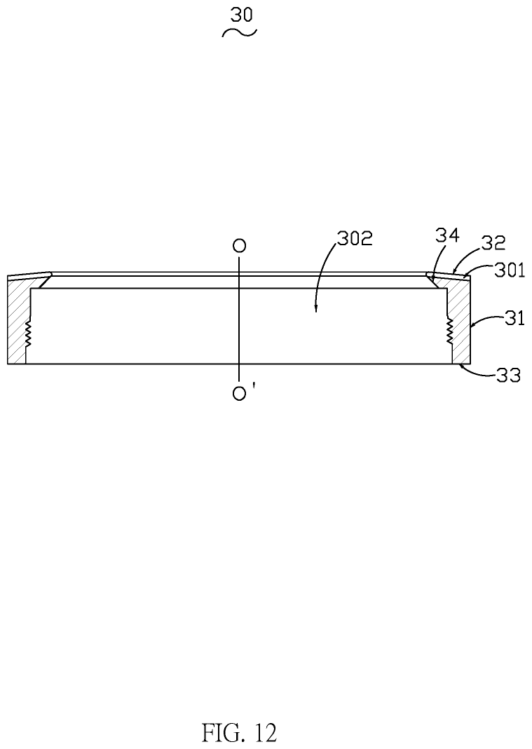

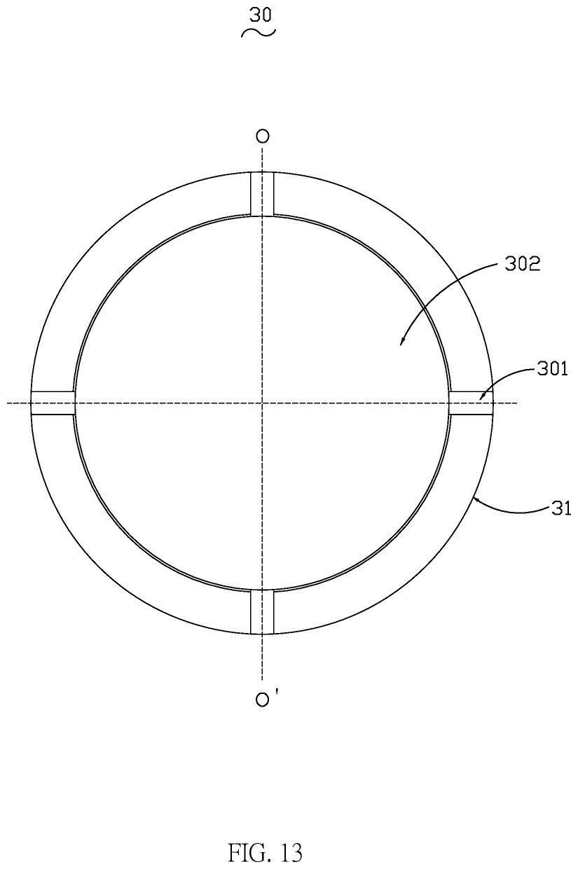

Preferably, the second groove 301 is connected to the image side surface 33. In this way, the outer annular surface 31 of the fixing part 30 has an greater area for holding and fixing, thereby facilitating the operation of the assembly machine on the fixing part 30. It should be noted that, in practical applications, the fixing part 30 may be provided with the second groove 301 in another manner. For example, as shown in FIG. 12 and FIG. 13, the second groove 301 may be connected to the inner annular surface 34 and communicates with the second receiving space 302.

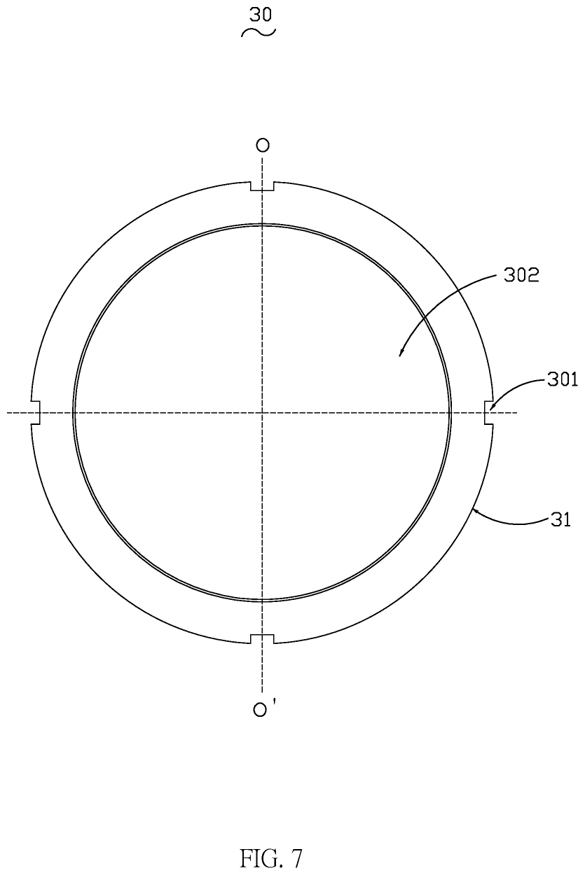

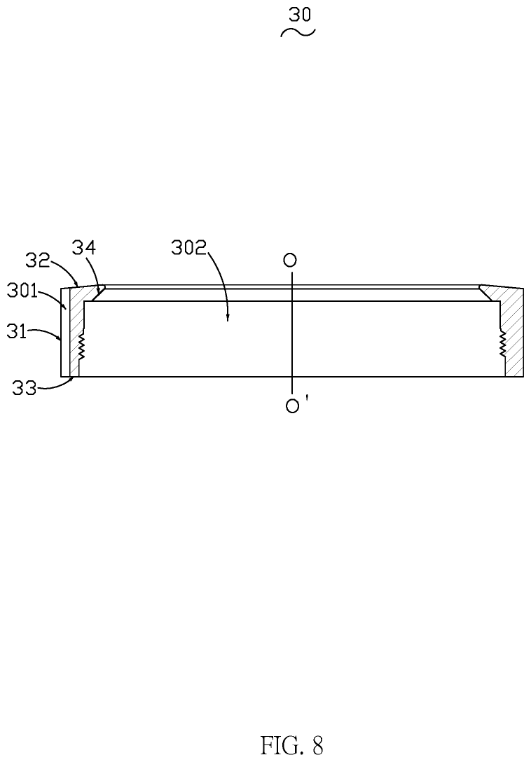

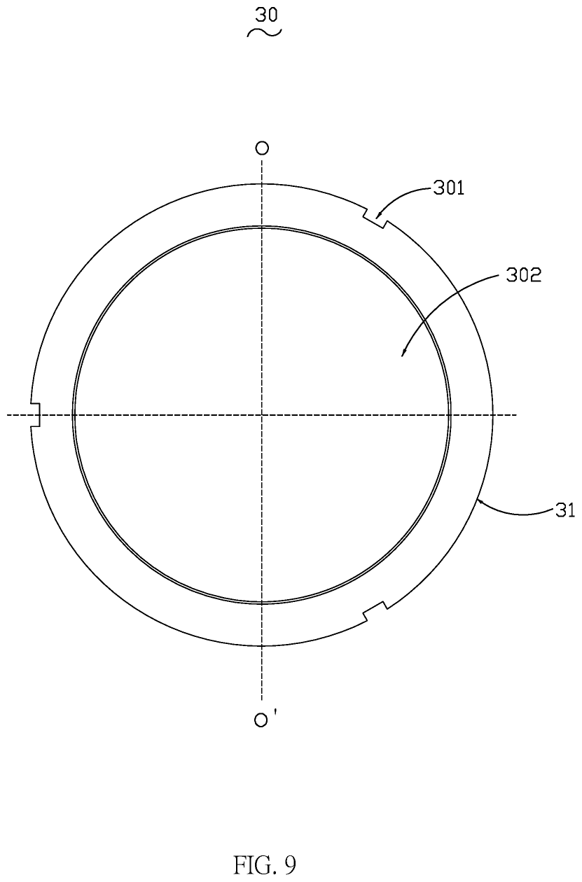

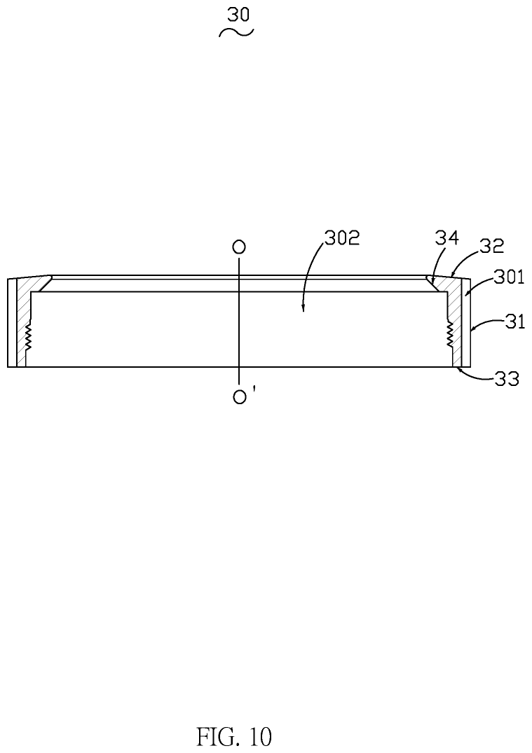

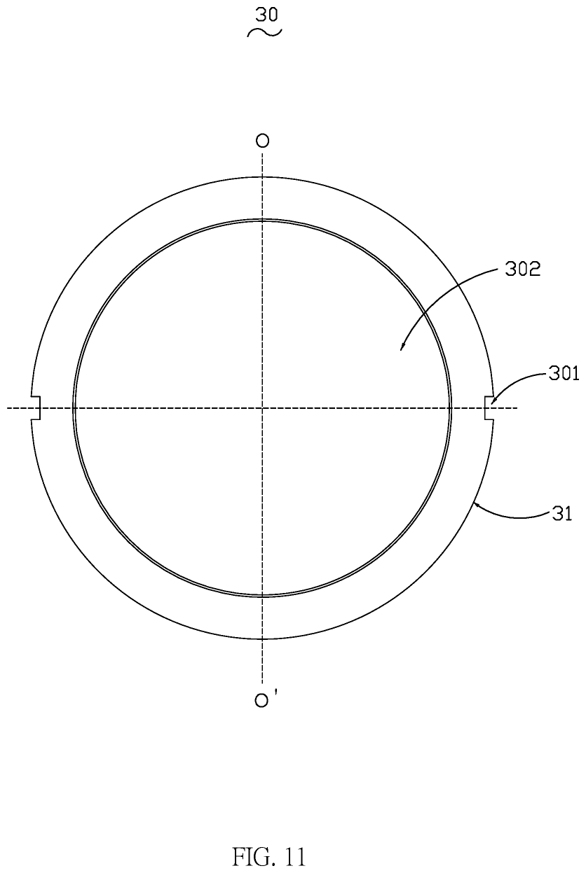

It should be noted that at least two second grooves 301 are provided, and the second grooves 301 are equally spaced apart from each other around the optical axis OO′. In this way, the fixing part 30 can be subjected to uniform force, thereby preventing the fixing part 30 from departing from the assembly machine during the assembling. For example, in the embodiment as shown in FIG. 6 and FIG. 7, four second grooves 301 are provided in the fixing part 30; in the embodiment as shown in FIG. 8 and FIG. 9, three second grooves 301 are provided; in the embodiment as shown in FIG. 10 and FIG. 11, two second grooves 301 are provided; and in the embodiment as shown in FIG. 12 and FIG. 13, four second grooves 301 are provided.

In this embodiment, the lens module 100 further includes a sealing ring 40 arranged between the lens barrel 10 and the first lens 20, so as to ensure a tight connection between the first lens 20 and the lens barrel 10, thereby avoiding the looseness of the first lens. More preferably, the lens barrel 10 is provided with a recess (not labeled with reference number), in which the sealing ring 70 is received. In this way, an effective space in the lens module 100 that is occupied by the sealing ring 40 can be reduced, which is conducive to the miniaturization of the lens module 100.

It should be noted that, the lens module 100 is provided with threads 40 for fixedly connecting the lens barrel 10 with the fixing part 30. In this embodiment, the fixing part 30 is a screw cap. During the assembling, the lens barrel 10 is fixed to the assembly platform, the assembly machine grasps the fixing part 30 and screws the fixing part 30 on the lens barrel 10 from the object side of the lens barrel 10, so that the fixing part 30 is tightly connected to the lens barrel 10. In this way, the first lens 20 arranged between the lens barrel 10 and the fixing part 30 is prevented from departing from the lens barrel 10, thereby ensure a stable fixing structure between the first lens 20, the fixing part 30 and the lens barrel 10. Therefore, the reliability of the lens module 100 is further improved.

Preferably, the lens module 100 is further provided with a thermosetting adhesive 60 for fixedly connecting the lens barrel 10 with the fixing part 30. The thermosetting adhesive 60 is provided at a joint between the lens barrel 10 and the fixing part, which reduces a looseness probability of the threads 50, thereby further improving the reliability of the lens module 100. Meanwhile, it can prevent external debris from entering the lens module 100 via the joint between the lens barrel 10 and the fixing part 30, thereby further optimizing the sealing performance of the lens module 100.

It should be understood by those skilled in the art that the lens module 100 may further include at least one second lens 70 received within the first receiving space 301 and located at the image side of the first lens 20.

It should be understood by those skilled in the art that the above embodiments are merely some specific embodiments of the present disclosure, and various changes in form and details may be made without departing from the scope of the present disclosure.

What is claimed is:

1. A lens module, comprising:
a lens barrel;
a first lens arranged at an object side of the lens barrel; and
a fixing part for pressing the first lens against the lens barrel from an object side of the first lens,
wherein the lens barrel comprises an outer wall surface around an optical axis of the lens module and facing away from the optical axis, and the outer wall surface is provided with a first groove,
the fixing part comprises an outer annular surface facing away from the optical axis, and the outer annular surface is provided with a second groove.

2. The lens module as described in claim 1, wherein the lens barrel further comprises an end surface close to an image side and connected to the outer wall surface, and the first groove is connected to the end surface.

3. The lens module as described in claim 2, wherein the lens barrel further comprises an inner wall surface around the optical axis and facing toward the optical axis, the inner wall surface defines a first receiving space, and the first groove is connected to the inner wall surface and communicates with the first receiving space.

4. The lens module as described in claim 1, wherein at least two first grooves are provided, and the at least two first grooves are equally spaced around the optical axis.

5. The lens module as described in claim 2, wherein at least two first grooves are provided, and the at least two first grooves are equally spaced around the optical axis.

6. The lens module as described in claim 3, wherein at least two first grooves are provided, and the at least two first grooves are equally spaced around the optical axis.

7. The lens module as described in claim 1, wherein the fixing part further comprises an object side surface close to the object side and connected to the outer annular surface, and the second groove is connected to the object side surface.

8. The lens module as described in claim 5, wherein the fixing part further comprises an image side surface close to an image side and connected to the outer annular surface, and the second groove is connected to the image side surface.

9. The lens module as described in claim 5, wherein the fixing part further comprises an inner annular surface around the optical axis and facing toward the optical axis, and the inner annular surface defines a second receiving space, and the second groove is connected to the inner annular surface and communicates with the second receiving space.

10. The lens module as described in claim 5, wherein at least two second grooves are provided, and the at least two second grooves are equally spaced around the optical axis.

11. The lens module as described in claim 6, wherein at least two second grooves are provided, and the at least two second grooves are equally spaced around the optical axis.

12. The lens module as described in claim 7, wherein at least two second grooves are provided, and the at least two second grooves are equally spaced around the optical axis.

13. The lens module as described in claim 1, wherein the lens barrel is fixedly connected to the fixing part by means of threads.

14. The lens module as described in claim 9, wherein the lens barrel is fixedly connected to the fixing part by means of a thermosetting adhesive.
